(19) United States
(12) Patent Application Publication
(10) Pub. No.: US 2010/0034938 A1
(43) Pub. Date: Feb. 11, 2010

(54) METHOD OF TREATING A PACKED FOOD FOR PURPOSES OF EXTENDING ITS SHELF-LIFE

(75) Inventors: Göran Stjernberg, Lund (SE); Jan Lagerstedt, Malmo (SE)

Correspondence Address: BUCHANAN, INGERSOLL & ROONEY PC, POST OFFICE BOX 1404, ALEXANDRIA, VA, 22313-1404, US

(73) Assignee: Tetra Laval Holdings & Finance S.A., Pully (CH)

(21) Appl. No.: 12/518,306

(22) PCT Filed: Oct. 3, 2007
(86) PCT No.: PCT/SE07/00874

§ 371 Date: Jun. 9, 2009

(30) Foreign Application Priority Data
Jan. 24, 2007 (SE) 0700160-5

(51) Int. Cl. A23L 3/02; B65B 55/02

(52) U.S. Cl. 426/398

(57) ABSTRACT

To extend shelf-life, a method of heat-treating a food packed in a packaging container of a packaging laminate comprising a layer of paper or paperboard and outer, liquid-tight coatings of plastic. The 9ackaging container is exposed to a liquid heating medium sprayed against outer walls of the packaging container to heat and hold the food at a predetermined treatment temperature during a predetermined period of time so as to exterminate, eliminate or deactivate harmful microorganisms inside the packaging container. Thereafter, the food is cooled by cold water sprayed against the outer walls of the packaging container. To avoid the risk that liquid penetrates into exposed incision edges on the outside of the packaging container during the heat treatment, the packaging container, before this treatment, is brought into contact with a hydrophobic impregnation agent for absorption and penetration of the hydrophobic impregnation agent in the exposed incision edges.

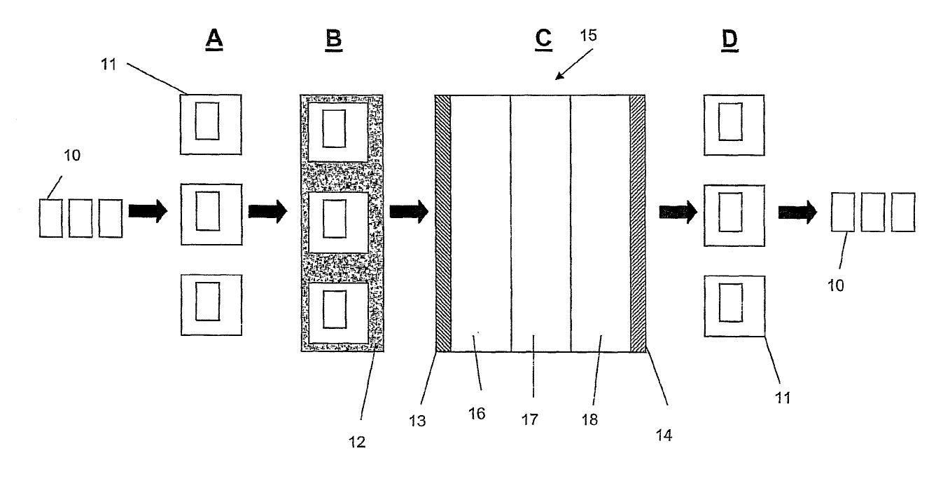

### TECHNICAL FIELD

The present invention relates to a method of treating a food, for purposes of extending its shelf-life, the food being packed in a packaging container of a packaging laminate comprising a layer of paper or paperboard and outer, liquid-tight coatings of plastic, in which method the packaging container with the packed food is exposed to a liquid heating medium so as to heat the food up to and hold it at a predetermined treatment temperature during a predetermined period of time, and in which method the packaging container is thereafter exposed to a liquid cooling medium to cool the heat-treated food.

### BACKGROUND ART

Food is often packed and transported in packaging containers of a single-use disposal nature, and one very large group of these single-use disposal packages is produced from a packaging material comprising a layer of paper or paperboard and outer, liquid-tight coatings of plastic.

In order to impart to the food extended shelf-life so that it withstands storage in the packaging container for a longer time than otherwise, the packing of the food may be put into effect under aseptic conditions, where both the food and the packaging material, prior to contact with one another, are separately treated in order to exterminate, eliminate or deactivate harmful microorganisms, in particular pathogens, and in which the treated food is enclosed in the treated packaging material under sterile conditions so as to avoid reinfection.

One similarly previously known alternative method to extend the shelf-life of a packed food is based on the principle of first packing and enclosing the food in a packaging container and thereafter subject the packed food, together with the packaging container, to a heat treatment which kills off the bacteria.

One such alternative method is described in, for example, EP 1 015 324 B1. According to this prior art method, the food is packed in a packaging container of paper or paperboard with outer, liquid-tight coatings of plastic. The packaging container is closed and sealed by thermosealing and is placed in a retort in which it is exposed to a heating medium, e.g. hot steam, so as to heat the food to a predetermined treatment temperature, generally between 80° C. and 140° C. When the treatment temperature has been reached, the food is held at this temperature during a predetermined period of time by the continued supply of heating medium, e.g. hot steam. The holding time at the treatment temperature may vary within broad limits, depending primarily on the type of food which is to be treated, but must be sufficiently lengthy to ensure a complete extermination of harmful microorganisms inside the packaging container, without the heat treatment having any negative effect on the quality properties of the food, such as flavour, consistency, colour, aroma etc. After the stay-time at the treatment temperature, the heating medium is replaced by a cooling medium, e.g. cold water, so as to cool the heat-treated food to a suitable temperature at which the packaging container is removed from the retort for further transport and handling.

A similar method is described in, for example, WO 2006/112765. According to this prior art method, the packaging container is filled with an already heat-treated and still hot (approx. 80-90° C.) food. After sealing of the filled packaging container by thermosealing, this is fed into and conveyed through a treatment chamber or tunnel for continued hot holding of the food at or about the relevant filling temperature, i.e. approx. 80-90° C., during a predetermined period of time so as to ensure complete extermination of harmful microorganisms inside the packaging container. The packaging container with the heat-treated food is thereafter cooled and removed from the treatment chamber for further transport and handling. Like the previously described method, also in this case the continued hot holding of the food may be put into effect by the supply of a liquid heating medium, such as, for example, hot steam.

No matter whether a heat treatment for extending shelf-life is to be carried out in a retort or in a treatment chamber or tunnel, as in the above-described prior art methods, the choice of heating medium to heat the packed food to the relevant treatment temperature is linked to needs which may be both counterproductive and even incompatible with one another. Such a need is naturally that the heating be carried out as rapidly and cost-effectively as possible, and a parallel need is that the heating and holding at such temperature is to have as slight negative effect as possible on both the food and its packaging container.

The need regarding rapid cost-effective heating is attained by the employment of a liquid heating medium, such as hot steam, which transfers heat to the walls of the packaging container more rapidly than a gaseous heating medium, but which, on the other hand, suffers from the drawback that it may penetrate into exposed incision edges on the outside of the packaging container and thereby jeopardize the integrity and dimensional stability of the packaging container. On the other hand, a gaseous heating medium shows no tendency to penetrate into the packaging walls in such sensitive incision edge areas and therefore makes possible a gentler heat treatment of the packaging container than does a liquid heating medium. On the other hand, a gaseous heating medium displays a less effective thermal transfer than a liquid heating medium and, as a result, counteracts the need and wish for a rapid and cost-effective heat treatment.

There is thus still a need in the art for a method of the type described by way of introduction which makes for a rapid and cost-effective heat treatment of a packed food in a paper- or paperboard package by means of a liquid heating medium, without the risk that the package be destroyed or deformed because of liquid penetration, or edge wicking, in the exposed incision edges of the packaging container.

### OBJECTS OF THE INVENTION

One object of the present invention is therefore to satisfy the need for such a method by means of which a rapid and cost-effective heat treatment of the packed food can be achieved using a liquid heating medium, without the risk that the packaging container be destroyed or deformed because of liquid penetration into exposed incision edges on the outside of the packaging container.

A further object of the present invention is to realise such a rapid, cost-effective and gentle method of heat treating a food which is packed in a paper- or paperboard package, by means of a liquid heating medium in a retort.

Still a further object of the present invention is to realise a method of rapidly and cost-effectively heat treating a food which is packed in a paper- or paperboard package, by means of a liquid heating medium in a tunnel or treatment chamber through which the packaging container is conveyed.

These and other objects and advantages will be attained according to the present invention by means of the method as claimed in independent Claim 1.

Expedient and preferred embodiments of the method according to the present invention possess the characterising features as set forth in the appended subclaims.

### BRIEF SUMMARY OF THE INVENTION

The present invention thus realises a method of treating, for purposes of extending its shelf-life, a food which is packed in a packaging container of a packaging laminate comprising a layer of paper or paperboard and outer, liquid-tight coatings of plastic, in which method the packaging container with the packed food is exposed to a liquid heating medium for heating the food up to and holding it at a predetermined treatment temperature during a predetermined period of time and in which method the packaging container is thereafter exposed to a liquid cooling medium so as to cool the heat-treated food. The method is characterised in that the packaging container with the packed food, before contact with the liquid heating medium, is brought into contact with a hydrophobic impregnation agent for penetration into or impregnation of exposed incision edges on the outside of the packaging container.

In connection with the contact of the packaging container with the hydrophobic impregnation agent, the impregnation agent will thus penetrate in between and impregnate the paper- or paperboard fibres within the region of such exposed incision edges on the outside of the packaging container, in which event the otherwise hydrophilic paper- or paperboard fibres are rendered hydrophobic and become water-repellent and thereby no longer inclined to absorb liquid in a subsequent exposure to moisture or liquid.

In order to facilitate this penetration of the impregnation agent in such sensitive areas of the packaging container, the impregnation agent is preferably emulsified or dispersed in a liquid, preferably water, to which the packaging container is exposed.

For example, said liquid in which the impregnation agent is emulsified or dispersed, can be applied to the packaging container in any suitable manner, such as by spraying the liquid in a finely divided form, or by passing the packaging container through a bath of said liquid containing said emulsified or dispersed agent.

More preferably, the packaging container is conveyed completely immersed through this bath, whereby it is ensured that all free incision edges on the outside of the packaging container are impregnated.

In order to hasten the penetration of the impregnation agent in incision edges on the outside of the packaging container, it is advantageous to warm and hold the temperature of the liquid at a higher temperature than the ambient temperature. Most preferably, the temperature of the liquid should be held at a temperature corresponding to or slightly exceeding the temperature of the packed food so as not unnecessarily to cool the food before the subsequent heat treatment. A suitable temperature range for the liquid is therefore 60-90° C.

The concentration of the hydrophobic impregnation agent may vary, but should in general be 1-5%, counted on the weight of the water bath.

The choice of hydrophobic impregnation agent is not critical to the present invention, but usable impregnation agents may be selected from a large number of known impregnation agents of a hydrophobic nature. The large multiplicity of usable hydrophobic impregnation agents is because the impregnation agent which is used in the method according to the present invention does not risk coming into contact with the packed food inside the packaging container, but merely penetrates in a slight distance between the fibres in the exposed incision edge regions where it remains.

Preferably, an impregnation agent is however selected which satisfies the requirements on food approval and which, therefore, has no negative effect on the food if it were to migrate into the packaging container and come into contact with the food. Among such preferred impregnation agents, mention might be made of surfactants which also contribute in reducing the surface tension in the water bath and thereby in facilitating the penetration into the incision edges on the outside of the packaging container. A suitable impregnation agent for use in accordance with the invention is an alkyl ketendimer (AKD), preferably an alkyl ketendimer comprising 16-22 carbon atoms in its fat tail. Most preferred is an alkyl ketendimer having 18 carbon atoms in its fat tail. For more detailed information of such usable alkyl ketendimers reference is made to European patent application No 027336569 which is incorporated herein as a reference.

Further objects, advantages and details of the present invention will be apparent from the following description with reference to the accompanying Drawing.

### BRIEF DESCRIPTION OF THE ACCOMPANYING DRAWING

In the accompanying Drawing, there is schematically illustrated the completion of a shelf-life-extending heat treatment of a packaging container employing the method according to the invention.

### DETAILED DESCRIPTION OF THE INVENTION

Even though the present invention will be described with particular reference to the accompanying Drawing, it is not restricted exclusively to this embodiment. For a person skilled in the art with the guidance of the present description, it will be obvious that modifications and alterations are possible without departing from the scope of the inventive concept, as this is defined in the appended Claims.

In the left-hand section of the FIGURE are shown a number of packaging containers 10 containing a food which, for purposes of extending its shelf-life, are to be heat treated using the method according to the present invention. The packaging containers 10 are produced from a web or from prefabricated blanks of a packaging laminate comprising a layer of paper or paperboard and outer, liquid-tight coatings of plastic which withstand a heat treatment at a temperature of approx. 80-140° C.

The packaging containers 10 are conveyed in the direction of the bold block arrows to a first station at A where they are placed in each respective retainer 11 by means of which the packaging containers 10 are to be conveyed further.

From the station at A, the retainers 11 are conveyed with each respective packaging container 10 to a station at B where they are led down into and through a water bath 12 containing a hydrophobic impregnation agent, such as an alkyl ketendimer comprising 16-22, preferably 18 carbon atoms in its fat tail, for contact with and absorption of the hydrophobic impregnation agent in the interspace between the paper- or paperboard fibres in exposed incision edges on the outside of the packaging containers 10.

In order to ensure absorption of the hydrophobic impregnation agent in all exposed incision edges, the retainers 11 should therefore be dimensioned and configurated so that no incision edges or parts thereof are prevented from coming into contact with the impregnation agent during passage through the water bath 12.

The concentration of the hydrophobic impregnation agent, such as an alkyl ketendimer comprising 16-22, preferably 18 carbon atoms in its fat tail, in the water bath 12 lies in the range of between 1 and 5%, and in addition the water bath 12 is held at a temperature corresponding to or slightly exceeding the temperature of the packed food. In general, the water bath 12 is held at a temperature of approx. 60-90° C. so as not to unnecessarily cool the food before the subsequent heat treatment.

As was previously pointed out, the choice of hydrophobic impregnation agent is not critical to the present invention, but preferably a surface tension reducing hydrophobic impregnation agent (a surfactant) is selected so as to hasten the penetration and absorption thereof in the incision edges of the packaging containers.

After the impregnation treatment at station B, the retainers 11 are led with each respective packaging container 10 further, as illustrated by means of the bold block arrow, to a treatment station C where the actual heat treatment takes place. Station C includes an apparatus 15 provided with inlet 13 and outlet 14 in which the retainers 11 with each respective packaging container 10 in sequence are led through a heating zone 16, a holding zone 17 and a cooling zone 18. The zones 16-18 can, but need not be, in open communication with one another, but may be separate and discrete from one another by means of partitions 19, 20 with openings (not shown) which are dimensioned to permit passage of the retainers 11 when these are conveyed through the apparatus 15.

After entry into the heating zone 16 via the inlet or the sluice 13, the packed food in the packaging containers 10 is heated during the passage of the retainers 11 through this zone 16 up to a predetermined temperature within the range of 80-140° C. by means of a liquid heating medium, preferably hot steam, which via nozzles (not shown) is sprayed against the outsides of the packaging containers 10.

In such cases where the packed food is, or includes, a liquid phase which is vaporised and thereby creates an excess pressure inside the packaging containers 10, it may be appropriate and occasionally necessary to apply a correspondingly elevated pressure inside the heating zone 16 in order to balance out the inner excess pressure and thereby avoid the risk that the packaging containers 10 rupture or “explode” because of the excess pressure inside the packaging containers 10.

When the food has been heated to the predetermined treatment temperature during the passage of the packaging containers 10 through the heating zone 16, these are conveyed further into a holding zone 17. In the holding zone 17, a liquid heating medium is supplied, preferably hot steam, which via nozzles (not shown) is sprayed against the outsides of the packaging containers 10 in order to hold the food at the relevant treatment temperature throughout the entire passage of the packaging containers 10 through the holding zone 17. As was mentioned previously, the time for the stay of the packaging containers 10 in the holding zone 17 is adapted so that the packed food is held at this temperature during a predetermined period of time in order to ensure the desired extermination, elimination or deactivation of harmful microorganisms inside the packaging containers 10.

From the holding zone 17, the packaging containers 10 are conveyed into the cooling zone 18 where the food is cooled by means of cold water which via nozzles (not shown) is sprayed against the outsides of the packaging containers 10 throughout the entire passage through the cooling zone 18.

The heat-treated and cooled packaging containers 10 are removed from the apparatus 15 via the outlet 14 and transported further in their respective retainers 11 in the direction of the bold block arrow to a station at D where the packaging containers 10 are released from the retainers 11.

The thus released packaging containers 10 are thereafter handled further in a conventional manner for transport out to shops or similar points of sale.

The above described embodiment thus shows how a paper- or paperboard based packaging container, in a very simple manner and using exclusively simple means, may be effectively protected against the penetration of liquid in exposed incision edges on the outside of the packaging container, when the packaging container is, during a heat treatment for extending the shelf-life of the food, exposed to a liquid medium, e.g. hot steam.

Even if the method according to the present invention has been described above with particular reference to a heat treatment which is carried out in a pasteurizer or tunnel through which the packed food is conveyed more or less continuously throughout the entire heat treatment, the present invention is not restricted exclusively to this specifically illustrated embodiment. Naturally, the method according to the present invention is applicable also in such cases where the heat treatment of the packed food is intended to be carried out batchwise in, for example, a retort in which the packaging containers are held enclosed in one and the same treatment chamber throughout the entire heat treatment. Furthermore, said liquid containg the impregnation agent can be applied to the packaging container in a finely divided form through spraying on the the outer walls of said container. In its very broadest scope, the method according to the present invention may in principle be employed in every conceivable heat treatment of a food which is packed in a paper- or paperboard package which in at least some stage during the heat treatment, is exposed to a liquid medium.

### INDUSTRIAL APPLICABILITY

The method according to the present invention may be employed to protect a paper- or paperboard package against the penetration of liquid in exposed incision edges on the outside of the packaging container when the package is, or runs the risk of being, exposed to a liquid medium. The method is particularly applicable to protect such a package which contains a food which, for purposes of extending its shelf-life, is to be subjected to a heat treatment during which the package is to be heated and/or cooled with a liquid medium, e.g. hot steam or hot or cold water, respectively, which is sprayed against the outside of the package. Examples of heat treatments of this type are retorting and pasteurisation which are carried out either continuously or batchwise.

1. A method of heat treating a food which is packed in a packaging container of a packaging laminate to extend a shelf-life of the food, the packaging laminate comprising a layer of paper or paperboard and outer, liquid-tight coatings of plastic, the method comprising exposing the packaging container with the packed food to a liquid heating medium to heat the food to a predetermined treatment temperature and hold the food at the treatment temperature during a predetermined period of time, exposing the packaging container, after this predetermined period of time, to a liquid cooling medium to cool the heat-treated food, and exposing the packaging container with the packed food, before the contact with the liquid heating medium, to a hydrophobic impregnation agent for absorption and penetration of the impregnation agent in exposed incision edges on an outside of the packaging container.

2. The method as claimed in claim 1, wherein said hydrophobic impregnation agent is emulsified or dispersed in a liquid which is applied to an outer surfaces of the packaging container in a finely divided form through spraying.

3. The method as claimed in claim 2, wherein the packaging container is immersed or dipped into or led through a liquid bath containing the hydrophobic impregnation agent.

4. The method as claimed in claim 3, wherein the packaging container is passed through the liquid bath and is held completely immersed in said liquid bath throughout its entire passage through the liquid bath.

5. The method as claimed in claim 3, wherein the liquid bath is held at a temperature above ambient temperature.

6. The method as claimed in claim 3, wherein the liquid is held at a temperature of 60-90° C.

7. The method as claimed in claim 3, wherein the concentration of the hydrophobic impregnation agent in the liquid is 1-5%, counted on the weight of the liquid.

8. The method as claimed in claim 1, wherein the hydrophobic impregnation agent comprises a surfactant.

9. The method as claimed in claim 8, wherein said surfactant is an alkyl ketendimer comprising 16 to 22 carbon atoms in its fat tail.

10. The method as claimed in claim 1, wherein the heat treatment is carried out either batchwise or continuously by retorting at a treatment temperature of 80-140° C.

11. The method as claimed in claim 1, wherein the heat treatment is carried out continuously by pasteurisation at a temperature of 60-90° C.

12. The method as claimed in claim 1, wherein said hydrophobic impregnation agent is emulsified or dispersed in water which is applied to the outer surfaces of the packaging container in a finely divided form through spraying.

13. A method of heat treating food packed in a packaging container to extend shelf life of the food, the packaging container being comprised of a packaging laminate in which outer, liquid-tight plastic coatings are positioned on opposite sides of a layer of paper or paperboard, the method comprising:
positioning the packaging container, in which is contained the food, in a liquid bath containing a hydrophobic impregnation agent to effect absorption and penetration of the hydrophobic impregnation agent in exposed incision edges on an outside of the packaging container;
moving the packaging container out of the liquid bath and directing a liquid heating medium to an outside surface of the packaging container positioned outside the bath to heat the food in the container to a treatment temperature;
moving the packaging container containing the food heated to the treatment temperature to a holding zone;
directing a liquid heating medium to the outside surface of the packaging container in the holding zone to hold the food at the treatment temperature during a predetermined period of time so that the food in the packaging container is heat-treated food;
moving the packaging container from the holding zone to a cooling zone; and
directing a liquid cooling medium to the outside surface of the packaging container in the cooling zone to cool the heat-treated food.

14. The method as claimed in claim 13, wherein the hydrophobic impregnation agent comprises alkyl ketendimer.

15. The method as claimed in claim 13, further comprising holding the packaging container completely immersed in the liquid bath.

16. The method as claimed in claim 13, wherein the liquid bath is held at a temperature above ambient temperature as the packaging container is positioned in the liquid bath.

17. The method as claimed in claim 13, wherein the liquid bath is held at a temperature of 60-90° C. as the packaging container is positioned in the liquid bath.

18. The method as claimed in claim 13, wherein the hydrophobic impregnation agent is present in the liquid in a concentration of 1-5%, based on the weight of the liquid.

19. The method as claimed in claim 13, wherein the hydrophobic impregnation agent comprises a surfactant.
